(19) United States
(12) Patent Application Publication
(10) Pub. No.: US 2021/0164682 A1
(43) Pub. Date: Jun. 3, 2021

(54) AIR QUALITY CONTROL SYSTEM AND MANAGEMENT

(71) Applicant: Telefonaktiebolaget LM Ericsson (publ), Stockholm (SE)

(72) Inventors: Anusha Pradeep MUJUMDAR, Bangalore (IN); Aneta VULGARAKIS FELJAN, Stockholm (SE); Ramamurthy BADRINATH, Bangalore (IN); Swarup Kumar MOHALIK, Bangalore (IN)

(21) Appl. No.: 17/257,204

(22) PCT Filed: Jul. 2, 2018
(86) PCT No.: PCT/SE2018/050716

§ 371 Date: Dec. 30, 2020

(51) Int. Cl. F24F 11/64; G05B 19/042

(52) U.S. Cl. CPC F24F 11/64; F24F 2110/50; G05B 19/042

(57) ABSTRACT

A method for managing an air quality control system is disclosed. The method includes monitoring air quality changes in an environment caused by a deployment of units, estimating individual rates of change of air quality achieved by specific units, and using the estimated rates of change to train a prediction model. The method further includes receiving a request for air quality control of a specified environment, using the trained prediction model to predict unit rates of change that would be achieved by units if deployed within the specified environment and generating an assignment of units for the specified environment on the basis of the predicted unit rates of change and a target air quality parameter.

### TECHNICAL FIELD

The present disclosure relates to method and a controller for managing an air quality control system, the air quality control system comprising a plurality of units operable to change air quality within an environment. The present disclosure also relates to an air quality control system and to a computer program product configured to carry out a method for managing an air quality control system.

### BACKGROUND

Air quality in indoor environments can greatly impact the wellbeing and productivity of human beings residing or working in such environments. The air in indoor environments is often polluted with chemicals such as benzene, formaldehyde, ozone and other volatile organic compounds, released through the use of household cleaners, refrigerators, air conditioners (AC) etc. When such pollutants exist in non-trace quantities in the air, they can cause breathing difficulties, skin irritations, and other undesirable reactions in humans.

In recent years, measures have been introduced which seek to reduce the introduction of pollutants into the air, for example by imposing penalties on harmful emissions. Such measures complement existing solutions for air quality improvement which address pollutants already present in an environment. Existing solutions for air quality improvement commonly rely on chemical or electrical filtration methods, or on ventilation, to reduce pollutant concentration within individual indoor environments. These solutions may be combined with monitoring of indoor air quality and raising an alarm when air quality measurements violate a given threshold representative of an acceptable environment for healthy working or living conditions.

While providing a reduction in pollutant concentration in indoor environments, chemical and electrical filters or air purifiers have the disadvantages of being relatively expensive and non-sustainable, and in addition may themselves release undesirable chemicals into the air, so contributing to the global problem of air quality.

Living plants have long been used on an ad-hoc basis to improve air quality in both indoor and outdoor environments, and urban planners are increasingly prioritising the deployment of gardens and urban forests to counteract the pollution common in urban areas. Research studies such as Wolverton, Bill C., Willard L. Douglas, and Keith Bounds. “A study of interior landscape plants for indoor air pollution abatement.” (1989), have also identified indoor plants that can effectively purify ambient air. However, the use of living plants or other more sustainable sources for active air quality improvement in indoor environments remains extremely limited.

### SUMMARY

It is an aim of the present disclosure to provide a method, controller, and computer program product which at least partially address one or more of the challenges discussed above.

According to a first aspect of the present disclosure, there is provided a method for managing an air quality control system, the air quality control system comprising a plurality of units operable to change air quality within an environment. The method comprises monitoring air quality changes in an environment caused by a deployment of units, estimating individual rates of change of air quality achieved by specific units, and using the estimated rates of change to train a prediction model. The method further comprises receiving a request for air quality control of a specified environment, using the trained prediction model to predict unit rates of change that would be achieved by units if deployed within the specified environment and generating an assignment of units for the specified environment on the basis of the predicted unit rates of change and a target air quality parameter. The method further comprises causing the generated assignment to be deployed, using the generated assignment to train an air quality control model, and using the air quality control model to generate an assignment of units for a new specified environment.

According to examples of the present disclosure, monitoring air quality changes in an environment caused by a deployment of units may comprise monitoring a change over time in concentration of at least one pollutant present in the environment.

According to examples of the present disclosure, estimating individual rates of change of air quality achieved by specific units may comprise, for a plurality of time windows, calculating a global rate of change of air quality in the environment, representing the global rate of change as the sum of the rates of change caused by the individual units of the deployment, and solving for the individual rates of change.

According to examples of the present disclosure, during each of the plurality of time windows, a deployment of units in the environment may be unchanged.

According to examples of the present disclosure, monitoring air quality changes in an environment caused by a deployment of units may comprise monitoring air quality changes caused by unit deployments in a plurality of environments, and estimating individual rates of change of air quality achieved by specific units may comprise, for each environment, calculating a global rate of change of air quality in the environment, and representing the global rate of change as the sum of the rates of change caused by the individual units of the deployment. Estimating individual rates of change of air quality achieved by specific units may further comprise solving for the individual rates of change on the basis of representations from a plurality of the environments.

According to examples of the present disclosure, using the estimated rates of change to train a prediction model may comprise assembling the estimated rates of change into a training data set, the training data set comprising inputs in the form of environment and unit specifications for ongoing and completed deployments, and outputs in the form of estimated rates of change of individual units for the ongoing and completed deployments. Using the estimated rates of change to train a prediction model may further comprise using the training data set to train a prediction model for mapping input environment and unit specifications to output individual rates of change for the specified units in the specified environments.

According to examples of the present disclosure, environment and unit specifications, may take the form of feature vectors. For an example case of environments in the form of rooms in a building, an environment specification feature vector may comprise a mix of static and dynamic parameters including room volume, surface area, floorplan, predicted room occupancy, ventilation, light, predicted presence of sources of pollutants, current air quality etc. For an example case of units in the form of plants (as discussed more fully below), a unit specification feature vector may comprise a mix of static and dynamic parameters including plant type, plant age, parameters indicative of plant health, plant location, plant size, soil quality measurements etc. Environment and unit specifications may be assembled from information maintained in a database, and may be supplemented with information contained in a request for air quality control of a specified environment.

According to examples of the present disclosure, generating an assignment of units for the specified environment on the basis of the predicted unit rates of change and a target air quality parameter may comprise obtaining, for the specified environment and on the basis of the target air quality parameter, a required global rate of change, calculating, from the predicted unit rates of change, a candidate set of unit assignments capable of achieving the required global rate of change, and selecting from the candidate set a unit assignment for implementation.

According to examples of the present disclosure, obtaining, for the specified environment and on the basis of the target air quality parameter, a required global rate of change may comprise obtaining a current value for the air quality parameter, obtaining predicted presence of factors affecting air quality within the environment, obtaining a time period for achieving the target value of the air quality parameter, and calculating a required global rate of change to achieve the target value within the time period and in the presence of the predicted factors.

According to examples of the present disclosure, the current and target value of the air quality parameter and predicted presence of factors affecting air quality within the environment may be obtained from the specification of the environment for air quality control, which may be assembled from data included with the request for air quality control and a database maintaining records of static and dynamic environment parameters. In some examples, the time period for achieving the target value of the air quality parameter may be included with the request for air quality control.

According to examples of the present disclosure, factors affecting air quality within the environment which include one or more of: room occupancy, sources of pollutants (air conditioning, heating|), ventilation etc.

According to examples of the present disclosure, the request for air quality control of a specified environment may comprise a request for air quality control of a plurality of specified environments. According to such examples, generating an assignment of units for the specified environment on the basis of the predicted unit rates of change and a target air quality parameter may comprise obtaining, for each specified environment and on the basis of a target air quality parameter, a required global rate of change, calculating, from the predicted unit rates of change, a candidate set of unit assignments capable of achieving the required global rates of change in the different environments, and selecting from the candidate set a unit assignment for implementation.

According to examples of the present disclosure, selecting from the candidate set a unit assignment for implementation may comprise generating a cost vector for each unit assignment within the candidate set and selecting the unit assignment having the lowest cost vector.

According to examples of the present disclosure, factors which may be included in the cost vector may include unit location, for example with respect to a location required by a candidate unit assignment, unit weight etc.

According to examples of the present disclosure, causing the generated assignment to be deployed may comprise sending a message to an executor, the message comprising the generated assignment.

According to examples of the present disclosure, using the generated assignment to train an air quality control model may comprise assembling the generated assignment into a training data set, the training data set comprising inputs in the form of environment specifications, required global rates of change for the specified environments, and average unit rates of change for ongoing and completed deployments, and outputs in the form of unit assignments for the ongoing and completed deployments. Using the generated assignment to train an air quality control model may further comprise using the training data set to train a model for mapping input environment specifications to output unit assignments for the specified environments.

According to examples of the present disclosure, using the air quality control model to generate an assignment of units for a new specified environment may comprise receiving a request for air quality control of a new specified environment, comparing the specification of the new environment to environment specifications in the training data, and, if a similarity between the specification of the new environment and at least one environment specification in the training data is above a threshold value, copying a unit assignment for the most similar of the environments in the training data to be an initial unit assignment for the new environment.

According to examples of the present disclosure, using the air quality control model to generate an assignment of units for a new specified environment may further comprise refining the initial unit assignment on the basis of the specification of the new environment, the similarity between the specification of the new environment and at least one environment specification in the training data, the required global rates of change for the specified environments in the training data and the average unit rates of change in the training data.

According to examples of the present disclosure, the method may further comprise monitoring air quality changes in the new environment caused by the initial or refined unit assignment when deployed in the new environment, and adjusting the unit assignment for the new environment on the basis of the monitored air quality changes.

According to examples of the present disclosure, the method may further comprise checking for a trigger and, on occurrence of the trigger, updating at least one of a currently deployed unit assignment, the prediction model and/or the air quality control model.

According to examples of the present disclosure, the trigger may comprise at least one of a timer and/or occurrence of a trigger event.

According to examples of the present disclosure, trigger events may be configured by a system operator and may be implementation specific. Example trigger events may include the generation of a threshold amount of new training data, a change in an environment specification, failure to obtain a target value of an air quality parameter within a target time period etc.

According to examples of the present disclosure, the units of the air quality control system may comprise at least one of living plants, air purifiers, air filters, incense, and/or essential oil delivery systems.

According to another aspect of the present disclosure, there is provided a computer program comprising instructions which, when executed on at least one processor, cause the at least one processor to carry out a method according to any one of the preceding aspects and/or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

According to another aspect of the present disclosure, there is provided a controller for managing an air quality control system, the air quality control system comprising a plurality of units operable to change air quality within an environment. The controller comprises a processor and a memory, the memory containing instructions executable by the processor such that the controller is operable to monitor air quality changes in an environment caused by a deployment of units, estimate individual rates of change of air quality achieved by specific units and use the estimated rates of change to train a prediction model. The controller is further operable to receive a request for air quality control of a specified environment, use the trained prediction model to predict unit rates of change that would be achieved by units if deployed within the specified environment, and generate an assignment of units for the specified environment on the basis of the predicted unit rates of change and a target air quality parameter. The controller is further operable to cause the generated assignment to be deployed, use the generated assignment to train an air quality control model, and use the air quality control model to generate an assignment of units for a new specified environment.

According to examples of the present disclosure, the controller may be further operable to perform a method according to any one of the preceding aspects and/or examples of the present disclosure.

According to another aspect of the present disclosure, there is provided a controller for managing an air quality control system, the air quality control system comprising a plurality of units operable to change air quality within an environment. The controller is adapted to monitor air quality changes in an environment caused by a deployment of units, estimate individual rates of change of air quality achieved by specific units and use the estimated rates of change to train a prediction model. The controller is further adapted to receive a request for air quality control of a specified environment, use the trained prediction model to predict unit rates of change that would be achieved by units if deployed within the specified environment, and generate an assignment of units for the specified environment on the basis of the predicted unit rates of change and a target air quality parameter. The controller is further operable to cause the generated assignment to be deployed, use the generated assignment to train an air quality control model, and use the air quality control model to generate an assignment of units for a new specified environment.

According to examples of the present disclosure, the controller may be adapted to perform a method according to any one of the preceding aspects and/or examples of the present disclosure.

According to another aspect of the present disclosure, there is provided a controller for managing an air quality control system, the air quality control system comprising a plurality of units operable to change air quality within an environment. The controller comprises a receiving module for receiving a request for air quality control of a specified environment, a database module for monitoring air quality changes in an environment caused by a deployment of units and a unit learning module for estimating individual rates of change of air quality achieved by specific units; for using the estimated rates of change to train a prediction model; and for using the trained prediction model to predict unit rates of change that would be achieved by units if deployed within the specified environment. The controller further comprises an allocating module for generating an assignment of units for the specified environment on the basis of the predicted unit rates of change and a target air quality parameter, a control module for causing the generated assignment to be deployed, and a service knowledge base for using the generated assignment to train an air quality control model and for using the air quality control model to generate an assignment of units for a new specified environment.

According to another aspect of the present disclosure, there is provided an air quality control system comprising a plurality of units operable to change air quality within an environment and a controller according to any one of the preceding aspects and/or examples of the present disclosure.

### BRIEF DESCRIPTION OF THE DRAWINGS

For a better understanding of the present disclosure, and to show more clearly how it may be carried into effect, reference will now be made, by way of example, to the following drawings in which:

FIGS. 1a and 1b show a flow chart illustrating process steps in a method for managing an air quality control system;

FIGS. 2a to 2e are flow charts illustrating sub steps that may be performed as part of the method of FIGS. 1a and 1b;

FIG. 3 is a block diagram representing elements of an air quality control system;

FIG. 4 is a block diagram representing elements of a master scheduling node in the system of FIG. 3;

FIG. 5 is a block diagram illustrating a learning system of the master scheduling node of FIG. 4;

FIG. 6 is a block diagram illustrating an estimator of the master scheduling node of FIG. 4;

FIG. 7 is a graph illustrating impact of room occupancy on presence of pollutants in an environment;

FIG. 8 is a graph illustrating air quality rate of change estimation;

FIG. 9 is a block diagram illustrating an allocator of the master scheduling node of FIG. 4;

FIG. 10 is a message flow diagram;

FIG. 11 is another message flow diagram;

FIG. 12 is another message flow diagram;

FIG. 13 is a block diagram illustrating functional units in a controller; and

FIG. 14 is a block diagram illustrating functional units in another example of a controller.

### DETAILED DESCRIPTION

Aspects of the present disclosure provide a method and controller which allow for dynamic management of units operable to change air quality within an environment. Such units may in some examples be plants or other sustainable sources of air quality, such as incense, essential oils or other filtering or air purifying agents. A two layer system of learning is employed to allow for the training firstly of a prediction model, to predict rates of change of air quality that may be achieved by units if deployed in an environment, and secondly of an air quality control model, to generate an assignment of units for a specified environment. The Internet of Things (IoT) may be leveraged to facilitate monitoring of air quality in an environment, for example via connected sensors, and to monitor parameters associated with individual units, for example plant health in the example of a plant based air quality control system.

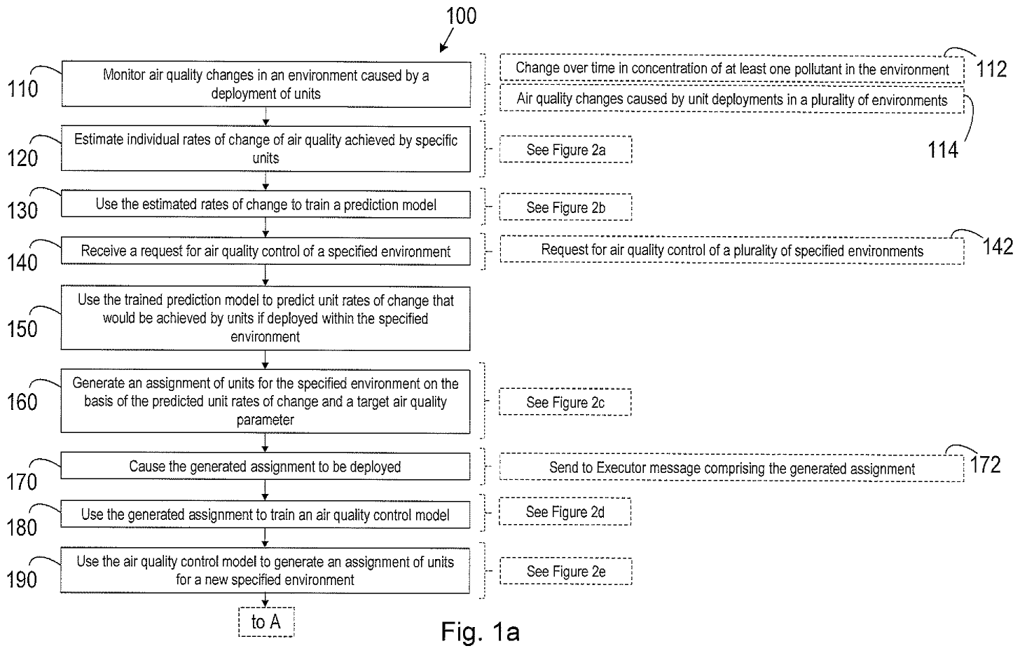

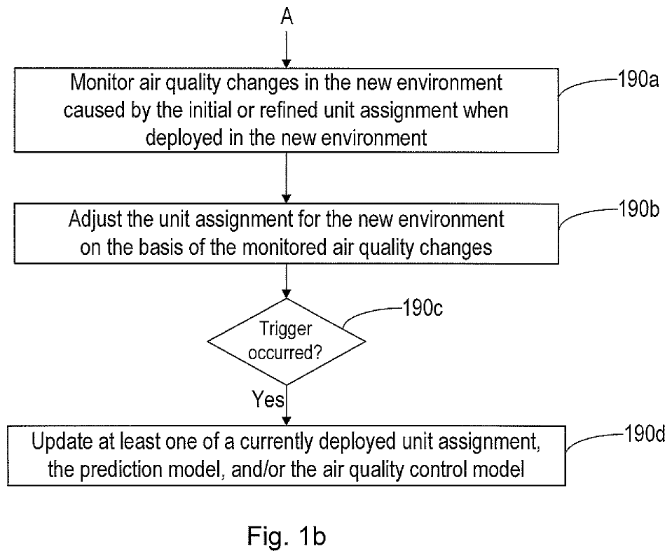

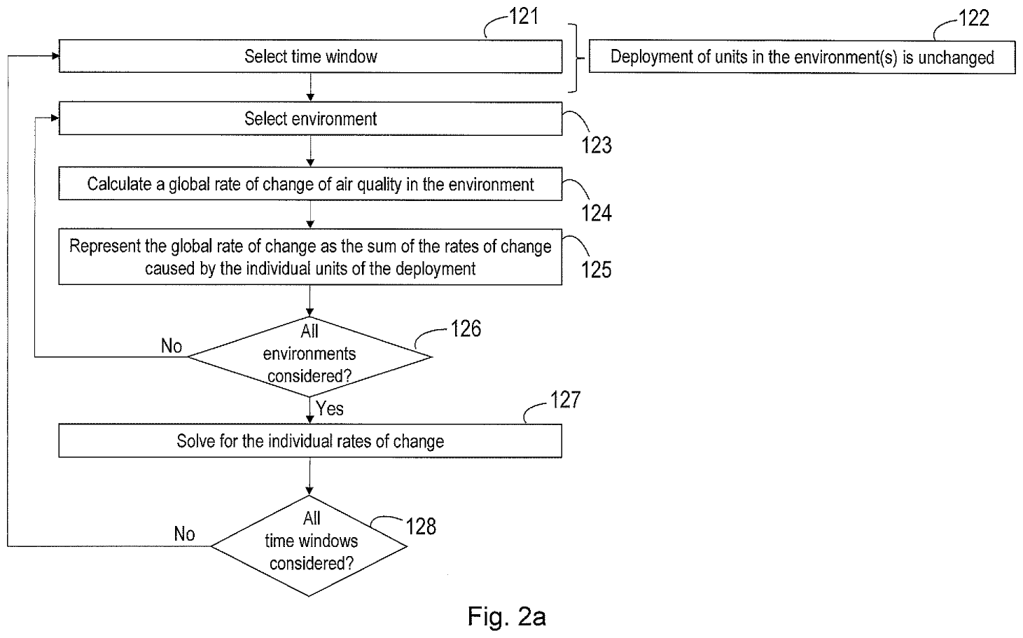

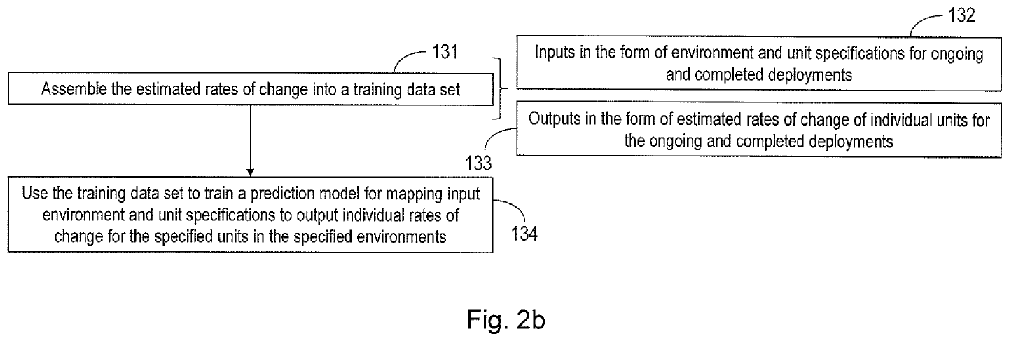

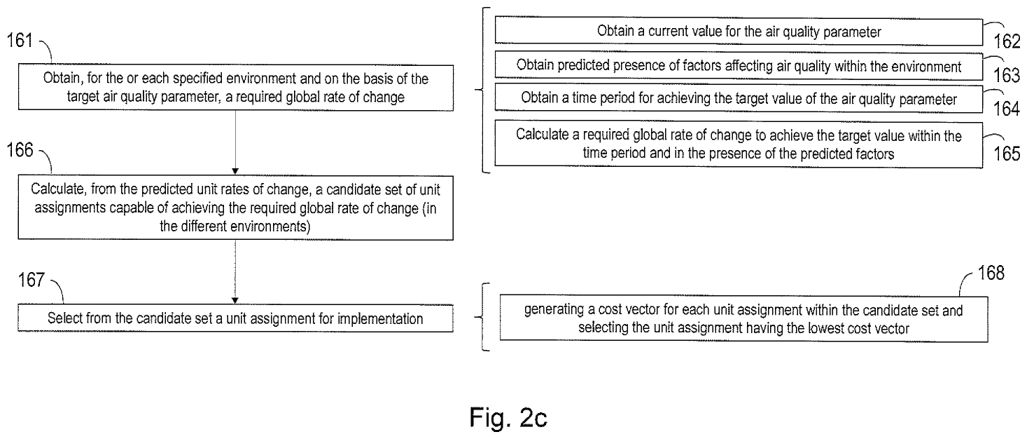

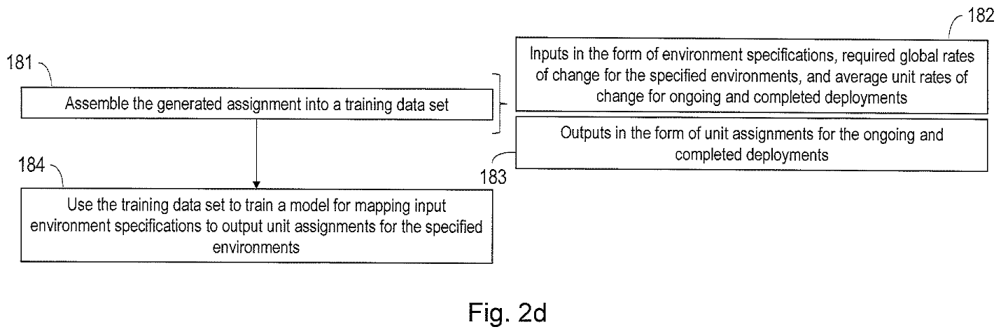

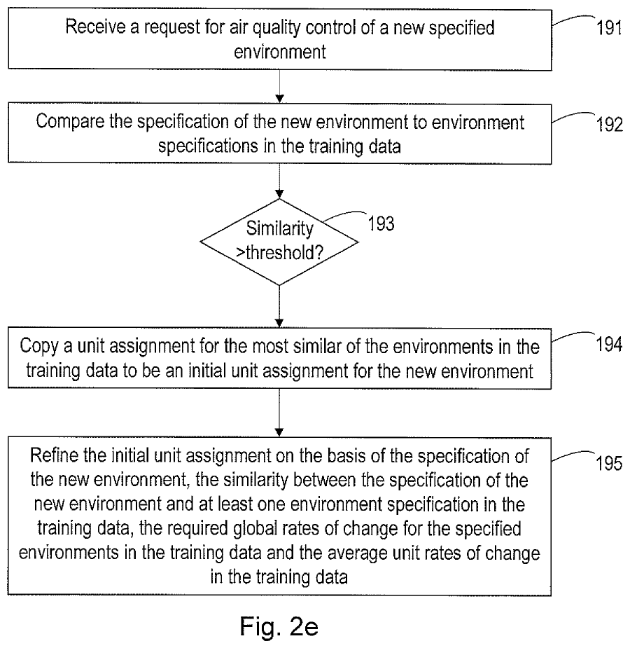

FIG. 1a is a flow chart illustrating process steps in a method 100 for managing an air quality control system in accordance with an example of the present disclosure. With reference to FIG. 1a, in a first step 110, the method comprises monitoring air quality changes in an environment caused by a deployment of units. The method then comprises estimating individual rates of change of air quality achieved by specific units in step 120, and using the estimated rates of change to train a prediction model in step 130. The method then comprises receiving a request for air quality control of a specified environment in step 140, using the trained prediction model to predict unit rates of change that would be achieved by units if deployed within the specified environment in step 150, generating an assignment of units for the specified environment on the basis of the predicted unit rates of change and a target air quality parameter in step 160, and causing the generated assignment to be deployed in step 170. The method then comprises using the generated assignment to train an air quality control model in step 180, and using the air quality control model to generate an assignment of units for a new specified environment in step 190. The individual steps of the method 100 are discussed in further detail below, with reference to FIGS. 1a, 1b and 2a to 2e.

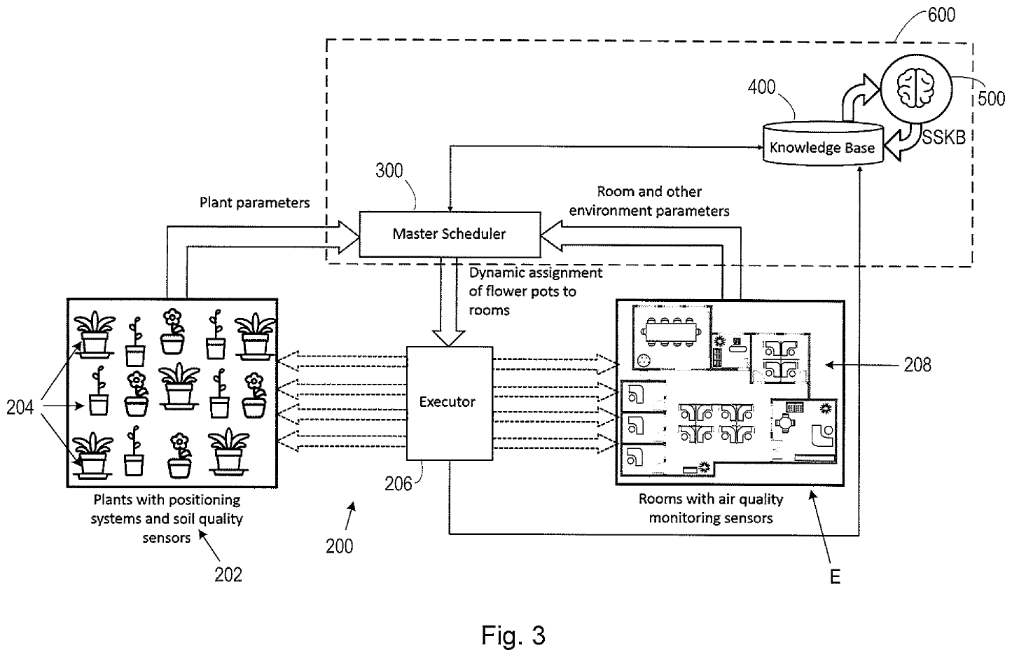

As discussed above, in some examples, the units of the system managed by the above method 100 may comprise plants, and FIG. 3 illustrates an example air quality control system, and control elements for management of the system, in which the units comprise living plants and may include plants of varying age, size, species etc.

Referring to FIG. 3, an example air quality control system 200 comprises a plurality of units 202 in the form of plants 204. In the illustrated example, the plants 204 are equipped with positioning systems and sensors which may enable monitoring of both the physical location of the plants and parameters indicating their state of health. The air quality control system further comprises an executor 206, operable to deploy the plants 204 in accordance with a generated assignment. The executor may in some examples be an automated system, such as a system of rails and motors for displacing plants around an environment, or may be realised in other ways. In some examples, a human operator may perform the functions of the executor 206. The system 200 further comprises a plurality of sensors 208 for monitoring air quality within an environment E in which the air quality control system may be deployed. Also illustrated in FIG. 3 are a master scheduler, or master scheduling node 300, a knowledge base 400 and a Sustainable Source Knowledge Base (SSKB) 500. The master scheduler 300, knowledge base 400 and SSKB 500 may all be elements of a controller 600 for managing the air quality control system 200. In some examples, one or more of the controller elements 300, 400, 500 may form part of the system 200. In other examples, one or more of the controller elements 300, 400, 500 may be separate from the system, such that the system itself and its management via the controller may be provided separately.

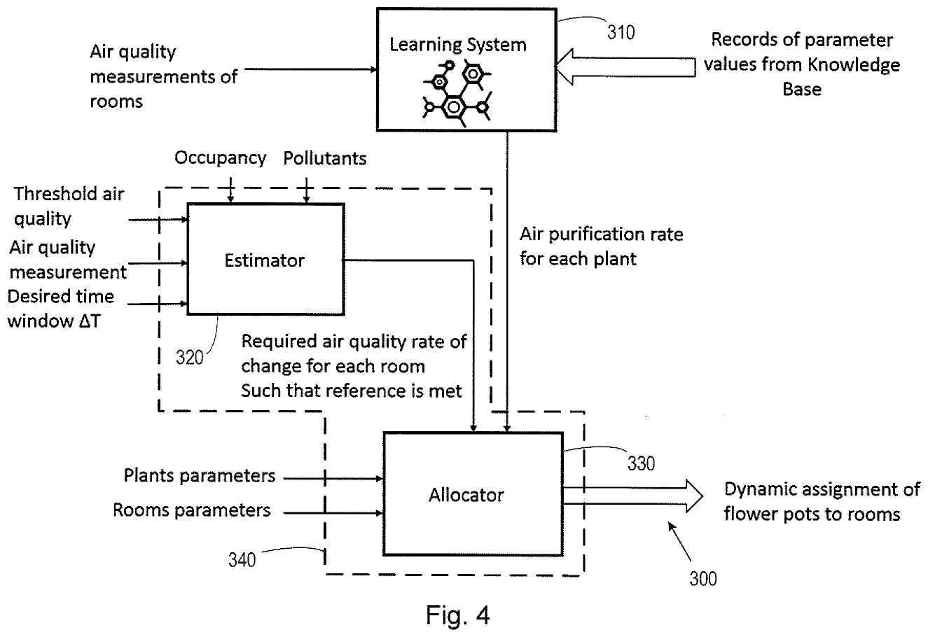

FIG. 4 illustrates component elements of an example master scheduler, such as the master scheduler 300 of FIG. 3. Referring to FIG. 4, the master scheduler 300 comprises a learning system 310, an estimator 320 and an allocator 340. In some examples, the estimator 320 and allocator 330 may together comprise an allocating module 340. As discussed in further detail below, the output of the master scheduler 300 is an assignment of plants to one or more rooms, the assignment including for example a number and type of plants to be assigned to the or each room.

An example implementation of the method 100 using the system components illustrated in FIGS. 3 and 4 is discussed below, with reference to FIGS. 1a to 12.

Referring initially to FIG. 1a, as discussed above, a first step 110 of the method 100 comprises monitoring air quality changes in an environment caused by a deployment of units. The present example discusses units in the form of living plants, although it will be appreciated that the example implementation is equally applicable to alternative units such as incense burners, essential oil dispensers, air purifiers, filters etc. The monitoring of step 110 may comprise monitoring a change over time in a concentration of one or more pollutant in the environment, as shown in step 112, and may in some examples comprise monitoring air quality changes caused by unit deployments in a plurality of environments, as shown in step 114. In the example of a building such as an office building, the rooms in the building may comprise individual environments, and air quality changes caused by deployments in several rooms may thus be taken into account. In some examples, the air quality changes may be monitored via sensor readings for detection of one or more pollutants. Such sensor readings may be collected by IoT sensors, which may send their readings to the knowledge base 400 or may in some examples send their readings directly to the master scheduler 300.

In step 120, the method 100 comprises estimating individual rates of change of air quality achieved by specific units. This step may in some examples be carried out by a learning system 310 of a master scheduler 300. As illustrated in FIG. 2a , the estimation in step 120 of individual rates of change of air quality achieved by specific units may comprise estimating individual rates of change over a time window T, and may incorporate information from a plurality of deployed environments. Referring to FIG. 2a , in a first step 121, the learning system 310 selects a time window T. The time window T may be a time window during which the deployment of units in one or all environments is unchanged as shown in step 122, allowing for more accurate estimation of individual rates of change achieved by the deployed units. In step 123, the learning system selects an environment, and in step 124, the learning system calculates a global rate of change of air quality in the environment. The learning system then represents the global rate of change as the sum of the rates of change caused by the individual units of the deployment in step 125. In step 126, the learning system checks whether all deployed environments have been considered, and if not, repeats steps 123 to 125 until all deployed environments have been considered. The learning system then solves for individual rates of change, for example using a linear equation solver in step 127. In step 128, the learning system considers whether a new time window is available and if so, repeats steps 121 to 127 to update the estimated individual rates of change.

An example estimation process is discussed below. The estimation process may take into account parameters describing the environment in which the units are deployed, and such parameters may be provided as part of a room specification, for example in the form of a feature vector. Suppose there are k environments in the form of rooms R1 . . . Rk. A room, generally denoted by R, may be specified in terms of various room characteristics or parameters including room volume, room surface area where units (plants) may be placed, room floorplan including the presence of furniture, ventilation possibilities, light availability, room occupancy, sources of pollutants (including for example air conditioning units, open windows) current pollutant levels etc. A room R may be specified e.g. as a vector of all these values as follows:

$$R ≡ [ \begin{matrix}Volume \\ Surface area \\ Current pollutant quantity \\ Ventilation \\ Light availability \\ Occupancy \\ Potential pollutant quantity\end{matrix} ]$$

The use of feature vectors for specifying an environment such as a room may enable two or more rooms to be compared using an appropriate distance measure such as cosine similarity or Jaccard coefficient. Thus, as discussed more fully below, learning for similar rooms may be transferred. As the system is reused and more data is gathered, the learning for the various cases can be reused, with no further need for training after a point. The feature vector representation also lends itself to efficient scaling.

Turning to the example estimation process, current estimates of the purification rate of individual units in the form of plants can be obtained through measurements taken or received during a deployment. In order to take account of dynamic changes in the rate over longer periods, rates may be estimated from observations over a sliding window of time D according to the following method.

When the concentration of particles is measured in a room at time t and then at t+D, the actual rate of purification in the room may be calculated during the time window D as:

rate(R)(t)=(c(t−D)*vol(R)−c(t)*vol(R))/D (Eq. 1)

Here c(t) is the concentration of particles (particles/volume) as measured by room sensors and vol(R) is the volume of room r. c(t)*vol(R) gives the total number of particles in the room R. Equation 1 holds when the plants in the room are not changed. If the interval [t−D, t] contains plant movements, the interval is divided into smaller subintervals (such as window T discussed above) during which the plant allocations remain constant. Multiple equations may therefore be generated corresponding to the subintervals T.

The actual purification rate(R)(t) is the result of the combined purification rates of the plants in the room. Let the plants in the room be p1, . . . , pn at time t, where n is a positive integer. Let the rates of purification for the plants p1, . . . , pn be denoted as r1, . . . rn. Then, the rate calculated at time t may be approximated with the sum of the purification rates of the plants at time t.

rate(R)(t)=r1(t)+ . . . +rn(t) (Eq. 2)

Taking into account plant movements, at any time t, for a room R, a set of equations of the form of Equation 2 may be generated, each corresponding to subintervals T of D during which plant allocations are constant.

Putting together all the equations of for all the rooms, at any time t, a set of equations the following form may be assembled:

r1+r2+ . . . =K1

r3+r4+ . . . =K2

The latest equations coming from each of the time points in the interval D may be retained, such that the number of equations is less than or equal to n (the number of rate variables). A linear equation solver may then be used to solve for the individual rates ri when possible. If solution is not possible, then the (possibly) simplified equations rᵢ₁+. . . rᵢₖ=r may be generated and each rate variable rᵢⱼ may be assigned the value r/k.

The complete algorithm is as follows. It will be noted that that the equations can be put in a canonical form where the summands are in increasing alphabetic order (i.e. r1<r2, r4<r8 etc), following which an alphabetic order on the equations themselves can be defined.

At time t:
1. Measure concentration c(t)
2. Identify subintervals in [t−D, t] where plant allocations have changed
3. For each [t1, t2]
   a. Add equation
      i. Sum(r(plants[t1:t2]))=c(t1)−c(t2)/D
   b. to pool of equations
4. Retain last n equations
5. Solve as much as possible
6. For equations that cannot be solved, order them (e.g. alphabetic in the names of variables)
7. and assign the average
8. Propagate and go to 5.

### EXAMPLE

Suppose, at time t, the following equations for the preceding interval D are available:

r1+r2+r3=10, as a result of plants p1, p2 and p3 in room R1

r3+r4=6, after plant p3 was moved to room R2 in which plant p4 was already deployed

r1+r2+r4=8, after plant p4 was moved to room R1 and plant p3 was moved to a balcony (pool of plants)

The above discussed process results in r3=4, r4=2, r1+r2=6, hence r1˜=3, r2˜=3 (˜= denotes estimate as determined by taking average value). Such estimates can be dynamically learned over a period of time, and continuously updated.

A factor that may also be included is the time of day/night, in order to account for plant respiration. The purification rate of plants differs during the day and at night, when several varieties plants produce carbon dioxide. A “night mode” may be introduced in the system to account for different rates of respiration as well as different rates of occupancy of rooms. If the occupancy is low and CO2 production rates are high, the plants may be automatically moved outdoors or to a balcony.

Referring again to FIG. 1a, the estimated rates of change of air quality achieved by individual units are then used to train a prediction model in step 130. This step may also be carried out by the learning system 310 of master scheduler 300. As illustrated in FIG. 2b, the step of using the estimated rates of change of air quality achieved by individual units to train a prediction model may comprise a first step 131 of assembling the estimated rates of change into a training data set. As illustrated in steps 132 and 133, the training data set may comprise inputs in the form of environment and unit specifications for ongoing and completed deployments, and outputs in the form of estimated rates of change of individual units for the ongoing and completed deployments. The environment specifications may take the form of feature vectors as discussed above. The plant specifications may also take the form of feature vectors, including a range of parameters to characterise individual plants. Such parameters may include plant species, age, size etc. as well as a range of parameters indicative of plant health such as soil sample measurements. Step 130 may then comprise the step 134 of using the training data set to train a prediction model for mapping input environment and unit specifications to output individual rates of change for the specified units in the specified environments. Supervised or reinforcement learning methods may be used to train the prediction model. In some examples, the learning system 310 may also consider community knowledge about each type of plant and its purification records, from research studies or other databases, in training the prediction model.

Referring again to FIG. 1a, the method 100 then comprises receiving a request for air quality control of a specified environment in step 140. As discussed above, the environment may be a room and may be specified via a feature vector of parameters describing the room. As illustrated in step 142, a request may be received for air quality control of a plurality of specified environments, for example all occupied rooms in a building, or all rooms having an air quality parameter below a certain level. The request may be received in a receiving module of a controller 600, and may in some examples be received from a task manager, as discussed in further detail below.

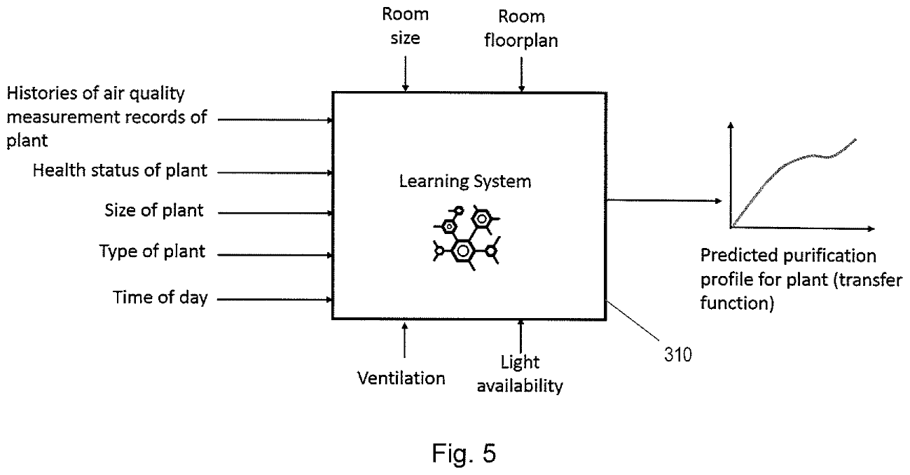

In step 150, the method 100 comprises using the trained prediction model to predict unit rates of change that would be achieved by units if deployed within the specified environment. This step may also be carried out by the learning system, 310 of the master scheduler 300. In step 150, the or each specified environment of the request, together with specifications for plants available for deployment, are input to the trained prediction model, and predicted rates of change that would be achieved by the available plants in the or each specified environment are output. This process is illustrated in FIG. 5, which shows the learning system 310, inputs of plant specification, historical plant data and room specification and an output of a predicted purification function for the specified plant in the specified environment. The plant specifications of available plants may be obtained from the knowledge base 400, which may be updated with both static and dynamic parameters for available plants.

The learning system 310 thus, over steps 120, 130 and 150, takes historical information about plant and environment parameters and predicts a transfer function (e.g. air purification rate as for example Particles/time) for each plant depending for example on the type of plant and any changes in its health and recent purification data and the specified environment. For each specific plant, a model of its air purification capability is learned over time by the learning system, in the form of a transfer function. As the purification profile of a plant depends on parameters of the environment in which it is deployed, these parameters are accounted for by the learning system.

Referring again to FIG. 1a, in step 160, the method 100 comprises generating an assignment of units for the specified environment on the basis of the predicted unit rates of change and a target air quality parameter. This step may be performed by the allocating module 340 of the master scheduler 300, the allocating module being comprised by the estimator 320 and the allocator 330. Referring to FIG. 2c, in a first step 161, the generating step 160 comprises obtaining, for the or each specified environment and on the basis of the target air quality parameter, a required global rate of change. This step bay be performed by the estimator 320 and, as illustrated at steps 162, 163, 164 and 165, may comprise, for the or each specified environment: obtaining a current value for the air quality parameter, obtaining predicted presence of factors affecting air quality within the environment, obtaining a time period for achieving the target value of the air quality parameter, and calculating a required global rate of change to achieve the target value within the time period and in the presence of the predicted factors.

The estimator 320 thus computes the air purification rate needed such that a desired air quality threshold is reached within a desired time period. The estimator 320 also accounts for any changes in air quality due to changes in occupancy in the room, or due to new pollutants being introduced (for example by air conditioning units or other sources of pollutants). The desired time period may be a sum of update time, transport time for the plants, and initial absorption time for the deployed plants.

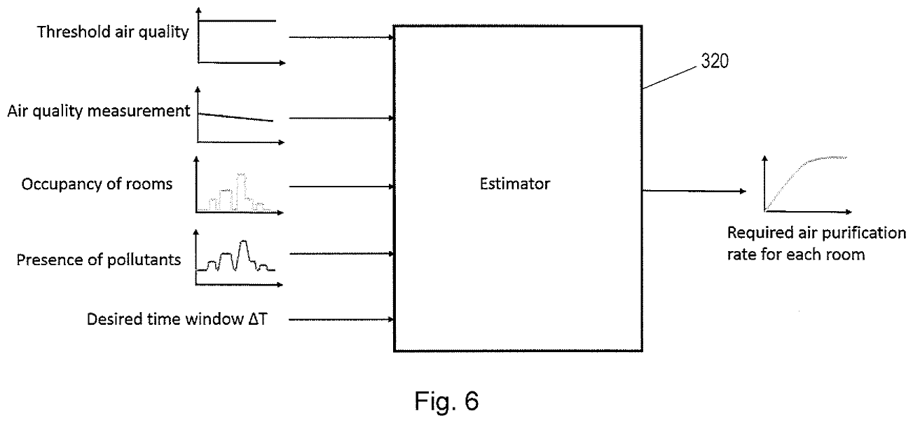

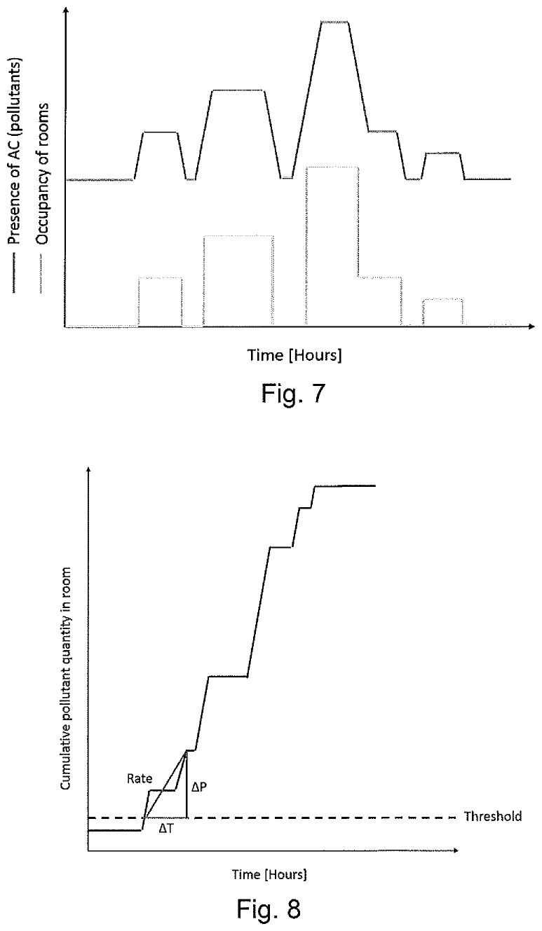

The estimator 320 may be implemented in various ways and an example implementation is illustrated in FIGS. 6 to 8. Suppose the occupancy of various rooms is known beforehand (due to meetings being fixed/classes being held/predictions from occupancy history etc.) and is as shown by the lower curve in FIG. 7. The pollutants expected due to the air conditioning being increased to account for this change in occupancy is shown by the upper curve in FIG. 7. The cumulative pollutant amount may then be computed as shown in FIG. 8, corresponding to occupancy rates illustrated in FIG. 7. The dashed horizontal line shows a target value of the air quality parameter, which may for example be defined by an organisation's sustainability policy. Given a time-window ΔT within which the air quality in a room is to be improved, the required purification rate may be computed as illustrated in FIG. 8 and discussed below.

Let C1 be the current concentration, and C2 be the required acceptable concentration level. Let V be the volume of the air in the room that needs to be purified. Suppose ΔT is the time duration within which the concentration is to be reduced from C1 to C2. Suppose ΔP is the change in pollutant levels required to achieve this reduction using a deployment of plants, then:

ΔP=(C1−C2)*V

Thus the required purification rate is given by:

R_req=ΔP/ΔT

Referring again to FIG. 2c, having obtained the required global rate of change as discussed above, the step 160 then comprises calculating, from the predicted unit rates of change from step 150, a candidate set of unit assignments capable of achieving the required global rate of change for the or each specified environment in step 166, and selecting from the or each candidate set a unit assignment for implementation in step 167. As illustrated in step 168, selecting from the candidate set a unit assignment for implementation may comprise generating a cost vector for each unit assignment within the candidate set and selecting the unit assignment having the lowest cost vector. Steps 166 and 167, including step 168, may be carried out by the allocator 330 of the allocating module 340.

The allocator 330 thus takes the required air purification rate for a specified environment, and the predicted air purification rates for each available plant, and computes the set of plants required in each room, such that the threshold air quality measurement is reached in a desired time window. For the assignment of plants into each room, the proximity of the plants to the rooms may also be accounted for via a cost vector. Proximity may be calculated from the room positions and the real-time plant positions.

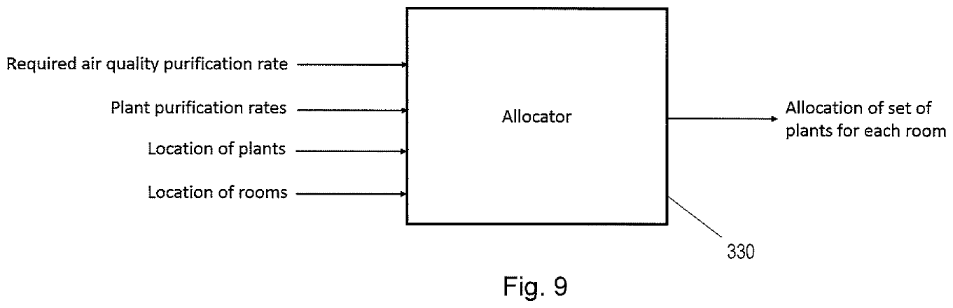

An example implementation of the allocator 330 is illustrated in FIG. 9 and discussed below.

Consider the pollutant to be measured in number of particles per unit volume, which may be in parts per million in the case of suspended particulate matter, or concentration in the case of a gaseous pollutant. As the required global reduction is provided by a set of plants, the rate R₁ (computed as the requirement for the room 1, as discussed above) should be achieved using plants by considering their individual rate of pollution reduction. If for Room 1 some arbitrary set S₁ of plants p1, p2, . . . , pn (n is the number of plants in S₁) with reduction rates r1, r2, . . . rn, is chosen, then the total reduction rate provided by the set S₁ of plants is given by Rₜₒₜ(S₁)=r1+r2+ . . . +rn. It is required that Rₜₒₜ(S₁)>=R₁ so that the pollutant level is controlled within the required time.

There is a cost associated with moving available plants to the required location. This cost could be expressed in terms of a combination of several factors such as distance of the plant from the destination, its weight or other factors. Distance may be calculated on the basis of room location from a room specification and plant location form a plant specification, which may be obtained from the knowledge base 400.

Let the costs for moving the plants p1, p2, . . . , pn be k1, k2, . . . , kn respectively. Then the total cost of the reconfiguration is

M(S₁)=k1+k2+ . . . +kn

The task for the allocator 330 is to select sets of plants S₁S₂ . . . Sₖ to be assigned to the rooms 1 . . . k so that

(1) the solution attempts to satisfy the requirement that Rₜₒₜ(S₁)>=Rᵢ for each room i, and where not possible, it minimizes the deficiency, and simultaneously

(2) the solution minimizes the cost M(S₁)+M(S₂)+ . . . +M(Sₖ)

This is a derivative of the well-known subset sum problem in computer science, which is NP-Complete, and efficient algorithms are not expected. In practice, this may eb formulated as an integer linear programming (ILP) problem and use an existing ILP solver.

The output of the allocator is the allocation of set of plants to rooms, i.e.

S={<Room1,S1>, <Room2,S2>, . . . <Roomk,Sk>}

Additional factors such as floor space availability in the rooms and corresponding plant size may also be considered to constrain the optimisation above, or may be incorporated into the cost vector.

Referring again to FIG. 1a, the method 100 then comprises causing the generated assignment to be deployed in step 170. As illustrated in step 172, this may comprise sending to an executor a message comprising the generated assignment. The executor may be executor 206 as illustrated FIG. 3. As discussed above, the executor may be an automated executor, a human operator or any other function capable of deploying units in accordance with a generated assignment.

Generation of an assignment may be conducted immediately on receipt of a new request for air quality control, and/or may be repeated according to an update cycle, for example to take account of changes to dynamic environment parameters such as room occupation. In such examples, at each update cycle (say every 30 minutes), the executor 206 takes an assignment from the allocator 330, and carries out the assignment (either autonomously or manually by transporting the plants to the specified rooms). Either the executor 206 or the allocator 330 may update the knowledge base 400 with position-based parameters for the deployed plants, and may send a message confirming deployment once the task is complete. This message may be sent to the entity from which the request for air quality control was received in step 140, which as discussed above may be a task manager.

Under normal operation, steps 110 to 170 may continue until terminated. An update cycle may be decided upon on the basis of requirements for the building, and may vary form a few minutes to several days. The system may also function as a decision support service, where the assignment is suggested to a human operator when requested.

It will be appreciated that steps 110 to 170 of the method 100 may be adapted to a range of deployment scenarios, including for example:
a single room with air quality to be improved, and a set of plants available for assignment;
multiple rooms with a finite set of plants available for assignment, to be distributed appropriately among the rooms such that air quality objectives are met for all the rooms. In some cases it may be known that certain rooms may remain empty (for example lecture halls in universities, banquet rooms in hotels, or meeting rooms in offices) and at such times air quality objectives may be lower than for other rooms, or not controlled at all in that period.
a large building with multiple rooms, and a pool of potted plants placed at an external location whose air quality is not monitored (such as a balcony/nursery area)

Steps 110 to 170 may also be adapted to various measures of air quality including different pollutants or combination of pollutants that may be considered for purification.

Referring again to FIG. 1a, the method 100 further comprises using the generated assignment to train an air quality control model in step 180, and using the air quality control model to generate an assignment of units for a new specified environment in step 190. Steps 180 and 190 may be carried out by the SSKB 500 in FIG. 3.

Referring to FIG. 2d, the step 180 of using the generated assignment to train an air quality control model may comprise a first step 181 of assembling the generated assignment into a training data set. As illustrated in steps 182 and 183, the training data set may comprise inputs in the form of environment specifications, required global rates of change for the specified environments, and average unit rates of change for ongoing and completed deployments, and outputs in the form of unit assignments for the ongoing and completed deployments. The step 180 may further comprise using the training data set to train a model for mapping input environment specifications to output unit assignments for the specified environments in step 184. The model may be trained using techniques such as supervised or reinforcement learning.

Referring to FIG. 2e, the step 190 of using the air quality control model to generate an assignment of units for a new specified environment may comprise receiving a request for air quality control of a new specified environment in step 191 and comparing the specification of the new environment to environment specifications in the training data in step 192. Step 190 may further comprise, if a similarity between the specification of the new environment and at least one environment specification in the training data is above a threshold value (step 193), copying a unit assignment for the most similar of the environments in the training data to be an initial unit assignment for the new environment in step 194. Step 190 may further comprise refining the initial unit assignment on the basis of the specification of the new environment, the similarity between the specification of the new environment and at least one environment specification in the training data, the required global rates of change for the specified environments in the training data and the average unit rates of change in the training data in step 195.

FIG. 1b illustrates additional steps which may in some examples be conducted as part of the method 100. Referring to FIG. 1b, the method 100 may further comprise the step 190a of monitoring air quality changes in the new environment caused by the initial or refined unit assignment when deployed in the new environment. The method may also comprise the step 190b of adjusting the unit assignment for the new environment on the basis of the monitored air quality changes. Steps 190a and 190b allow for feedback to the SSKB 500 which may be used to improve the operation of the SSKB.

The method 100 may further comprise the step 190c of checking for a trigger and on occurrence of the trigger, in step 190d, updating at least one of a currently deployed unit assignment, the prediction model and/or the air quality control model. The trigger may comprise a timer, for example corresponding to an update cycle as discussed above, or may comprise an trigger event, such as a threshold amount of new training data, occurrence of an anomaly, a change in environment or plant specifications etc. Steps 190a to 190d may be carried out by appropriate elements of the system 200 and/or controller elements such as the master scheduler 300, including learning system 310, estimator 320 and allocator 330, knowledge base 400 and SSKB 500.

The SSKB 500 thus initially collects the rates required for each room given the room characteristics, and the average rates for each type of plant. The SSKB is updated periodically. Air quality control may then be applied across buildings in the following way. Initially, the system estimates, learns, optimises and allocates for the first P buildings.

When an assignment is requested for a completely new building say (P+1)th building, a similarity operation is first conducted between a new room's vector of characteristics with the existing room vectors in the SSKB. If the similarity is greater than a threshold, the learning rates are transferred, and an initial allocation is copied. Finer refinement may then be done to make the allocation suitable for the scenario. The SSKB continues improving during its online operation, as new training data is generated allowing updated training of the air quality control model. The SSKB enables the system to be used as a Service, such as Plants-as-a-Service or Sustainable Sources-as-a-Service. The SSKB improves over time as use increases, owing to feedback via the sensors in monitored environments with deployed units.

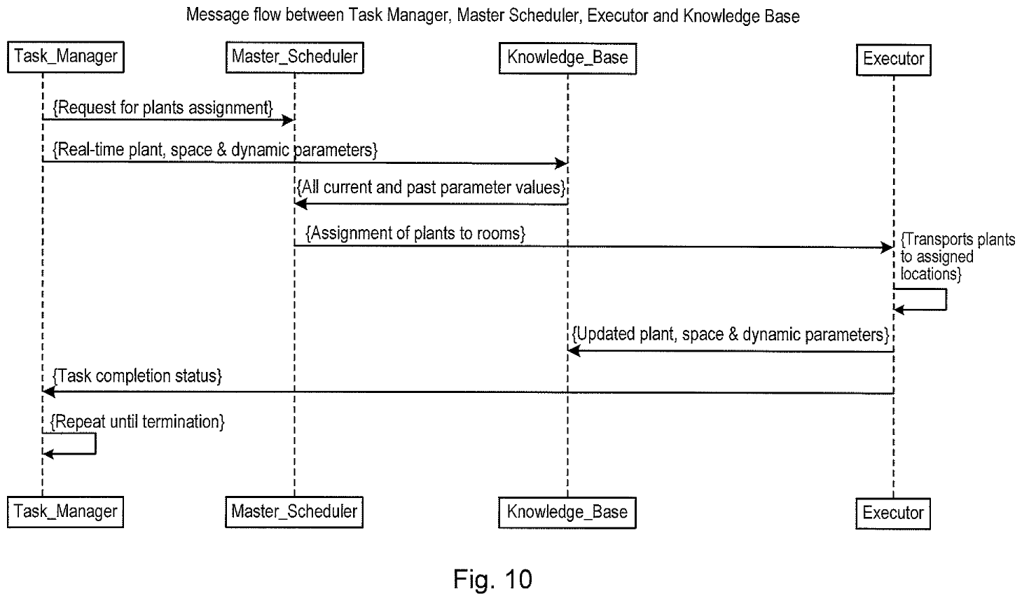

FIGS. 10 to 12 illustrate example message flows for an implementation of the method 100 in conjunction with the system 200 and elements of the controller 600.

Referring initially to FIG. 10, a task manager requests a new plant assignment from the master scheduler 300. The task manager could be a human operator or an automated system, which may for example send requests in accordance with a configured schedule. The knowledge base 400 then inputs up to date values of current and past parameters (plant and environment parameters) to the master scheduler 300, allowing for the generation of appropriate environment and unit feature vectors. The master scheduler 300 carries out allocation of plants to rooms, which allocation is sent to the executor 206. The executor 206 carries out the steps needed to perform the assignment (either through autonomous motion planning of the plants, or other means of transporting plants to the allocated locations), and updates the task manager when the plants are deployed. The executor also updates the knowledge base 400 with the new locations of the plants which have been deployed. The Task Manager repeats the process until the process is terminated (either externally by a human operator, or in a timed manner).

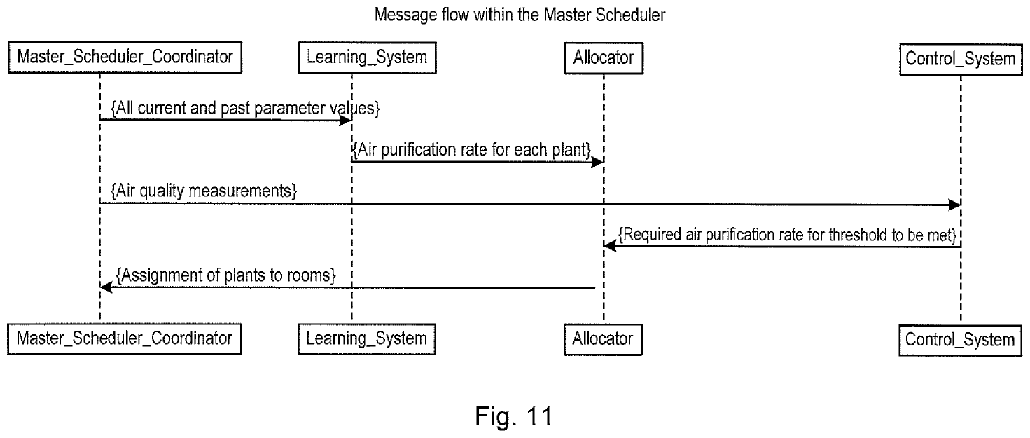

FIG. 11 illustrates message flow within the master scheduler 300. Referring to FIG. 11, the request for assignment may be received at a master scheduler coordinator (not shown) which may coordinate the cooperation between the elements of the master scheduler. The learning system, 310 is first invoked to predict the air purification rate for each available plant taking into account the environment specified in the request, changes in plant purification capabilities as well as dynamic changes in demand (due to occupancy changes, air conditioning status etc.) Then, the estimator 320 computes the required air purification rate which can meet the threshold air purity within a given time window. The required air purification rate as well as predicted purification rate for each plant are fed in as inputs to the allocator 330, which calculates an assignment of plants into different rooms. This assignment is sent to the executor 206 via the coordinator.

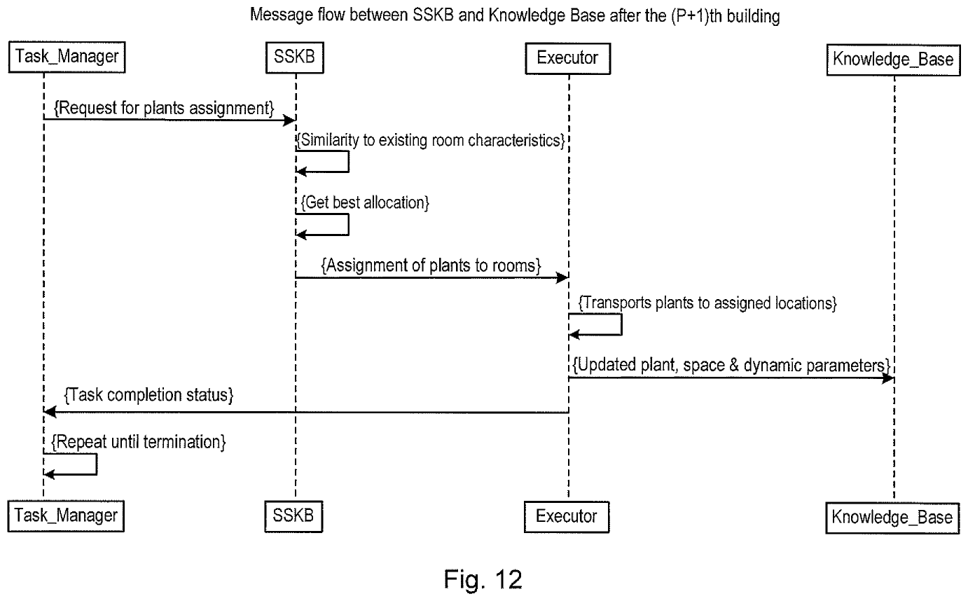

The SSKB 500 is continuously updated with new training data in the form of environment specifications, required global rates of change for the specified environments, average unit rates of change for ongoing and completed deployments, and unit assignments for the ongoing and completed deployments. This training data allows for the training of the air quality control model within the SSKB 500 to generate an assignment of plants directly from a new request for air quality control. Over time, the SSKB improves and can minimize the amount of learning needed. At the limit, no learning or allocation will be needed, and the SSKB can directly provide an allocation simply from the room characteristics. Thus over time, after the first P buildings, most of the message flow may involve the SSKB as illustrated in FIG. 12. A request for a new assignment is received at the SSKB 500, which calculates similarity to existing room characteristics and obtains a best plant assignment, which assignment is sent to the executor. The executor carries out the assignment and updates the knowledge base 400 and informs the task manager that the task is complete.

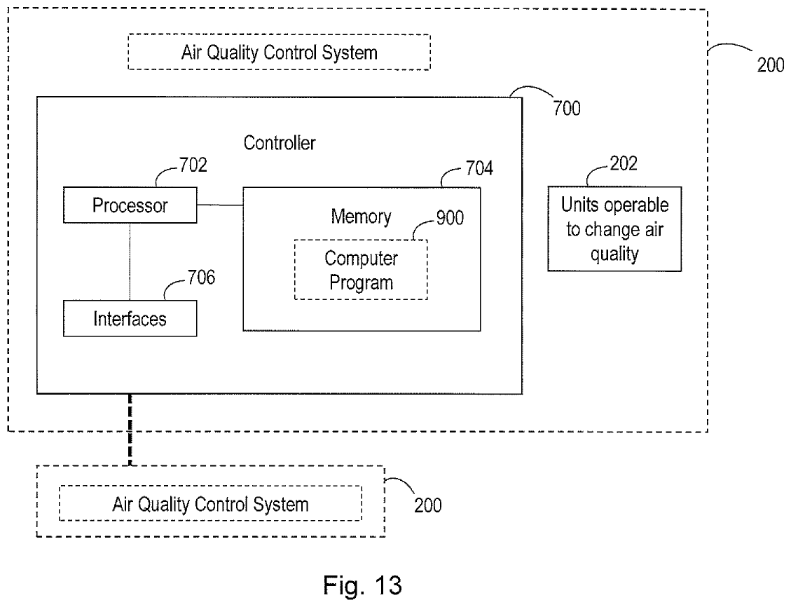

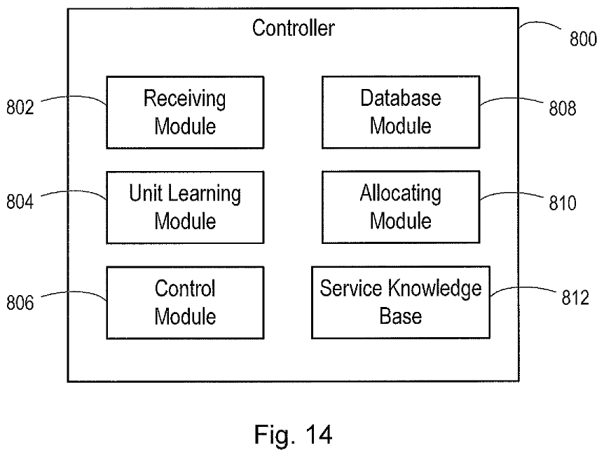

FIGS. 13 and 14 are block diagrams illustrating examples of controller 700, 800 which may carry out examples of the method 100.

FIG. 13 illustrates a first example of controller 700, which may implement some or all of the steps of method 100, for example on receipt of suitable instructions from a computer program 900. Referring to FIG. 13, the controller 700 may be part of an air quality control system 200, the system 200 also comprising a plurality of units operable to change air quality within an environment. In other examples, the controller 700 may be external to the air quality control system 200. The controller 700 comprises a processor 702, a memory 704 and interfaces 670606. The memory 704 contains instructions executable by the processor 702 such that the controller 700 is operative to conduct some or all of the steps of the method 100. The instructions stored on the memory 704 may in some examples comprise the computer program 900.

FIG. 14 illustrates another example of controller 800, which may also be a part of an air quality control system 200 or may be separate from the air quality control system 200.

Referring to FIG. 14, the controller 800 comprises a plurality of functional modules, which may execute the steps of method 100 on receipt of suitable instructions for example from a computer program. The functional modules of the controller 800 may be realised in any appropriate combination of hardware and/or software. The modules may comprise one or more processors and may be integrated to any degree. In one example, the controller 800 comprises a receiving module 802 for receiving a request for air quality control of a specified environment and a database module 808 for monitoring air quality changes in an environment caused by a deployment of units. The controller 800 further comprises a unit learning module 804 for estimating individual rates of change of air quality achieved by specific units; for using the estimated rates of change to train a prediction model; and for using the trained prediction model to predict unit rates of change that would be achieved by units if deployed within the specified environment. The controller 800 further comprises an allocating module 810 for generating an assignment of units for the specified environment on the basis of the predicted unit rates of change and a target air quality parameter, a control module 810 for causing the generated assignment to be deployed, and a service knowledge base 812 for using the generated assignment to train an air quality control model; and using the air quality control model to generate an assignment of units for a new specified environment.

According to some examples of the present disclosure, the unit learning module 804 may comprise a learning system such as the learning system 310 described above. The allocating module 810 maybe an allocating module such as the allocating module 340 and may comprise an estimator 320 and an allocator 340 as described above. The unit learning module 804 and allocating module 810 may be assembled in a master scheduler, such as the master scheduler 300 described above. The database module 808 may comprise a knowledge base 400 as described above, and the service knowledge base 810 may comprise an SSKB 500 as described above.

It will be appreciated that the components of controllers 600, 700, 800 are logical and may be placed in a distributed fashion on various devices. In one example case referred to as plants-on-wheels, plants may be equipped with wheels for their movement, and may autonomously plan their own path after the assignment is calculated. In such an example, the SSKB can be realised on the Cloud, the elements of the master scheduler may be on an edge network for each building, and the executors of the system can be fully distributed, in the form of actuators on each plant pot. The system can be implemented as a service over an IoT infrastructure of sensors, actuators etc.

Examples of the method and controller of the present disclosure allow for a sustainable and autonomous system of air quality control, according to which a master scheduler may be used to dynamically allocate units, such as plants, to rooms in indoor spaces. The master scheduler may be implemented either in a picocell or in the Cloud. The master scheduler uses a learning system to model plant purification capabilities using histories obtained during the purification process, which capabilities are fed into an allocator for decision making. The allocator of the master scheduler dynamically calculates an assignment of plants to rooms, accounting for the required air purification characteristics for each room, proximity, and purification capability of each plant. The output of the master scheduler allows for the gradual development of a Sustainable Source Knowledge Base which allows for provision of the method as a service and for efficient scaling.

An example air quality control system, including a controller for carrying out examples of the method described above, may include:
Units such as potted plants equipped with positioning systems and sensors to measure their health (e.g. soil quality sensors);
Air quality sensors in environments such as rooms for which air quality is to be controlled
A database for saving all measurements and calculated values of plant parameters, for example their estimated observed purification rates, room parameters, such as room sizes, and other environment parameters, such as room occupancy, and for providing such parameters as inputs to the master scheduler node. The database contains also the inventory of plants available to be allocated, occupancy of rooms, room sizes, and learnt plant purification rates.
A learning system for dynamically calculating air purification rates for each plant, taking inputs from real time plant health measurements, as well as from a knowledge base containing histories of purification rates. The learning system may account for space considerations (such as air volume to surface area in rooms), current temperature, presence of pollutant sources (such as air conditioners, open windows, cleaning chemicals etc.), and occupancy of rooms. The learning system may also take into account plant parameters such as size or foliage, and any changes in air purification rates over time. The learning system may also consider any external records of air purification performance of various types of plants (such as from research studies/data collected separately).
An estimator for calculating a rate of change of air quality required for a threshold value to be achieved in a given time window, based on air quality values and rates of change measured in each room, and a required air quality value for each room.
An allocator for taking as input the required purification rate, current air quality rate of change, purification profiles of different plants in the system and current/expected occupancy in the rooms, and outputting an allocation of plants to each room. The allocation may specify the set of potted plants to be assigned to each room.
An executor for transporting plants either through motion planning, or through manual transportation.
A Sustainable Source Knowledge Base (SSKB) containing an air quality rating for each room, along with the room characteristics. In addition, the SSKB may contain the purification rate for each type of plant. The SSKB may improve with use across buildings, allowing for use as-a-service, e.g. in the form of Plants-as-a-Service (PaaS), or Sustainable Sources-as-a-Service.

Aspects and examples of the present disclosure thus allow for the dynamic management of a system comprising units operable to change air quality within an environment, so improving air quality in residential, commercial or public buildings. Inexpensive, sustainable units such as potted plants may be used to improve air quality. Changes in air purification profiles for individual units, as well as variations in factors affecting air quality in a controlled environment may be accounted for using a database and learning system. Accuracy may improve over time, as computational load decreases owing to the use of a trained air quality control model. Examples of the present disclosure may easily be applied to a new building, as learning, estimation and allocation may be performed in real time. After initial training is complete, improvements in speed and accuracy and reductions in computational load are provided through the use of the two tier learning structure.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing an air quality control system, the air quality control system comprising a plurality of units operable to change air quality within an environment, the method comprising:
monitoring air quality changes in an environment caused by a deployment of units;
estimating individual rates of change of air quality achieved by specific units;
using the estimated rates of change to train a prediction model;
receiving a request for air quality control of a specified environment;
using the trained prediction model to predict unit rates of change that would be achieved by units if deployed within the specified environment;
generating an assignment of units for the specified environment on the basis of the predicted unit rates of change and a target air quality parameter;
causing the generated assignment to be deployed;
using the generated assignment to train an air quality control model; and
using the air quality control model to generate an assignment of units for a new specified environment.

2. A method as claimed in claim 1, wherein monitoring air quality changes in an environment caused by a deployment of units comprises monitoring a change over time in concentration of at least one pollutant present in the environment.

3. A method as claimed in claim 1, wherein estimating individual rates of change of air quality achieved by specific units comprises, for a plurality of time windows:
calculating a global rate of change of air quality in the environment;
representing the global rate of change as the sum of the rates of change caused by the individual units of the deployment; and
solving for the individual rates of change.

4. A method as claimed in claim 3, wherein, during each of the plurality of time windows, a deployment of units in the environment is unchanged.

5. A method as claimed in claim 1, wherein monitoring air quality changes in an environment caused by a deployment of units comprises monitoring air quality changes caused by unit deployments in a plurality of environments; and
wherein estimating individual rates of change of air quality achieved by specific units comprises:
for each environment:
calculating a global rate of change of air quality in the environment; and
representing the global rate of change as the sum of the rates of change caused by the individual units of the deployment; and
solving for the individual rates of change on the basis of representations from a plurality of the environments.

6. A method as claimed in claim 1, wherein using the estimated rates of change to train a prediction model comprises:
assembling the estimated rates of change into a training data set, the training data set comprising:
inputs in the form of environment and unit specifications for ongoing and completed deployments, and
outputs in the form of estimated rates of change of individual units for the ongoing and completed deployments; and
using the training data set to train a prediction model for mapping input environment and unit specifications to output individual rates of change for the specified units in the specified environments.

7. A method as claimed in claim 1, wherein generating an assignment of units for the specified environment on the basis of the predicted unit rates of change and a target air quality parameter comprises:
obtaining, for the specified environment and on the basis of the target air quality parameter, a required global rate of change;
calculating, from the predicted unit rates of change, a candidate set of unit assignments capable of achieving the required global rate of change; and
selecting from the candidate set a unit assignment for implementation.

8. A method as claimed in claim 7, wherein obtaining, for the specified environment and on the basis of the target air quality parameter, a required global rate of change comprises:
obtaining a current value for the air quality parameter;
obtaining predicted presence of factors affecting air quality within the environment;
obtaining a time period for achieving the target value of the air quality parameter; and
calculating a required global rate of change to achieve the target value within the time period and in the presence of the predicted factors.

9. A method as claimed in claim 1, wherein the request for air quality control of a specified environment comprises a request for air quality control of a plurality of specified environments, and wherein generating an assignment of units for the specified environment on the basis of the predicted unit rates of change and a target air quality parameter comprises:
obtaining, for each specified environment and on the basis of a target air quality parameter, a required global rate of change;
calculating, from the predicted unit rates of change, a candidate set of unit assignments capable of achieving the required global rates of change in the different environments; and
selecting from the candidate set a unit assignment for implementation.

10. A method as claimed in claim 9, wherein selecting from the candidate set a unit assignment for implementation comprises generating a cost vector for each unit assignment within the candidate set and selecting the unit assignment having the lowest cost vector.

11. A method as claimed in claim 1, wherein causing the generated assignment to be deployed comprises sending a message to an executor, the message comprising the generated assignment.

12. A method as claimed in claim 1, wherein using the generated assignment to train an air quality control model comprises:
assembling the generated assignment into a training data set, the training data set comprising:
inputs in the form of environment specifications, required global rates of change for the specified environments, and average unit rates of change for ongoing and completed deployments, and
outputs in the form of unit assignments for the ongoing and completed deployments; and
using the training data set to train a model for mapping input environment specifications to output unit assignments for the specified environments.

13. A method as claimed in claim 12, wherein using the air quality control model to generate an assignment of units for a new specified environment comprises:
receiving a request for air quality control of a new specified environment;
comparing the specification of the new environment to environment specifications in the training data; and
if a similarity between the specification of the new environment and at least one environment specification in the training data is above a threshold value:
copying a unit assignment for the most similar of the environments in the training data to be an initial unit assignment for the new environment.

14. A method as claimed in claim 13, wherein using the air quality control model to generate an assignment of units for a new specified environment further comprises:
refining the initial unit assignment on the basis of the specification of the new environment, the similarity between the specification of the new environment and at least one environment specification in the training data, the required global rates of change for the specified environments in the training data and the average unit rates of change in the training data.

15. A method as claimed in claim 1, further comprising:
monitoring air quality changes in the new environment caused by the initial or refined unit assignment when deployed in the new environment; and
adjusting the unit assignment for the new environment on the basis of the monitored air quality changes.

16. A method as claimed in claim 1 the method further comprising:
checking for a trigger; and
on occurrence of the trigger, updating at least one of:
a currently deployed unit assignment
the prediction model;
the air quality control model.

17. A method as claimed in claim 16, wherein the trigger comprises at least one of:
a timer;
occurrence of a trigger event.

18. A method as claimed in claim 1, wherein the units of the air quality control system comprise at least one of:
living plants;
air purifiers;
air filters;
incense;
essential oil delivery systems.

19. A computer program product comprising non transitory computer readable media having stored thereon a computer program comprising instructions which, when executed on at least one processor, cause the at least one processor to carry out a method according to claim 1.

20-21. (canceled)

22. A controller for managing an air quality control system, the air quality control system comprising a plurality of units operable to change air quality within an environment, the controller comprising a processor and a memory, the memory containing instructions executable by the processor such that the controller is operable to:
monitor air quality changes in an environment caused by a deployment of units;
estimate individual rates of change of air quality achieved by specific units;
use the estimated rates of change to train a prediction model;
receive a request for air quality control of a specified environment;
use the trained prediction model to predict unit rates of change that would be achieved by units if deployed within the specified environment;
generate an assignment of units for the specified environment on the basis of the predicted unit rates of change and a target air quality parameter;
cause the generated assignment to be deployed;
use the generated assignment to train an air quality control model; and
use the air quality control model to generate an assignment of units for a new specified environment.

23. A controller as claimed in claim 22, wherein the controller is further operable to estimate individual rates of change of air quality achieved by specific units for a plurality of time windows by:
calculating a global rate of change of air quality in the environment;
representing the global rate of change as the sum of the rates of change caused by the individual units of the deployment; and
solving for the individual rates of change.

24. A controller for managing an air quality control system, the air quality control system comprising a plurality of units operable to change air quality within an environment, the controller adapted to:
monitor air quality changes in an environment caused by a deployment of units;
estimate individual rates of change of air quality achieved by specific units;
use the estimated rates of change to train a prediction model;
receive a request for air quality control of a specified environment;
use the trained prediction model to predict unit rates of change that would be achieved by units if deployed within the specified environment;
generate an assignment of units for the specified environment on the basis of the predicted unit rates of change and a target air quality parameter;
cause the generated assignment to be deployed;
use the generated assignment to train an air quality control model; and
use the air quality control model to generate an assignment of units for a new specified environment.

25. A controller as claimed in claim 24, wherein the controller is adapted to estimate individual rates of change of air quality achieved by specific units for a plurality of time windows by:
calculating a global rate of change of air quality in the environment;
representing the global rate of change as the sum of the rates of change caused by the individual units of the deployment; and
solving for the individual rates of change.

26. A controller for managing an air quality control system, the air quality control system comprising a plurality of units operable to change air quality within an environment, the controller comprising:
a receiving module for receiving a request for air quality control of a specified environment;
a database module for monitoring air quality changes in an environment caused by a deployment of units;
a unit learning module for estimating individual rates of change of air quality achieved by specific units; for using the estimated rates of change to train a prediction model; and for using the trained prediction model to predict unit rates of change that would be achieved by units if deployed within the specified environment;
an allocating module for generating an assignment of units for the specified environment on the basis of the predicted unit rates of change and a target air quality parameter;
a control module for causing the generated assignment to be deployed; and
a service knowledge base for using the generated assignment to train an air quality control model; and using the air quality control model to generate an assignment of units for a new specified environment.

27. An air quality control system comprising a plurality of units operable to change air quality within an environment and a controller as claimed in claim 22.
